(19) United States
(12) Patent Application Publication
(10) Pub. No.: US 2013/0264420 A1
(43) Pub. Date: Oct. 10, 2013

(54) ADAPTABLE AIRPORT SYSTEM WITH INDUSTRIAL ZONES AND CLEAN ENERGY GENERATION

(71) Applicant: Michael Bickelmeyer, Parma Heights, OH (US)

(72) Inventor: Michael Bickelmeyer, Parma Heights, OH (US)

(21) Appl. No.: 13/442,406

(22) Filed: Apr. 9, 2012

(51) Int. Cl. B64F 1/00; E21D 9/00; G21C 9/00; E01F 3/00

(52) U.S. Cl. 244/114 R; 405/132; 376/277

(57) ABSTRACT

An environmentally-friendly airport with renewable energy sources. The environmentally-friendly airport includes a security zone encompassing the land area of the airport, and a plurality of runways across the land area. There are one or more terminals within the security zone encompassing the land area of the airport. Further, a plurality of power generator systems are disposed within the land area for generating renewable, clean energy, and an industrial zone is placed within a boundary formed by the runways.

### TECHNICAL FIELD OF THE INVENTION

The present invention relates generally to an environmentally-friendly airport with renewable energy sources. More specifically, the present invention relates to an airport complete with a plurality of runways with one or more terminals, preferably within a security zone and a plurality of power generator systems disposed within the airport for generating renewable, clean energy.

### BACKGROUND OF THE INVENTION

Airports, particularly large international airports, have long been centers of both commerce and pollution. On one hand, they offer one of the most significant means to transport goods and people. A high capacity airport can represent a boon to an emerging local economy or can act as the backbone of a more established region. The airport itself can provide immense employment benefits and it can also boost the presence of other sectors, like tourism, industry, education, and military, among many others.

On the other hand, these benefits come at a considerable cost. One of the greatest drawbacks associated with airports is pollution. Such pollution can come in various forms. Departing and arriving aircraft generate huge levels of noise, which presents a major disturbance to people living in proximity to the airport. These aircraft also emit large quantities of pollutant gases. Moreover, the construction of a massive airport often strips the surrounding area of natural features to counterbalance such pollution. The proposed invention offers a solution to optimize the human utility of an airport while reducing its negative impact on its surrounding.

### SUMMARY OF THE INVENTION

According to an embodiment of the present invention, an environmentally-friendly airport with renewable energy sources. The environmentally-friendly airport includes a security zone encompassing the land area of the airport, and a plurality of runways across the land area. There are one or more terminals within the security zone encompassing the land area of the airport. Further, a plurality of power generator systems are disposed within the land area for generating renewable, clean energy, and an industrial zone is placed within a boundary formed by the runways.

According to another embodiment of the present invention, a method of operating an environmentally-friendly airport with renewable energy sources. The method includes encompassing the land area of the airport with a security zone and running a plurality of runways across the land area. The method further includes constructing one or more terminals within the security zone encompassing the land area of the airport. The method further includes generating renewable, clean energy using a plurality of power generator systems within the land area. Finally, the method includes providing an industrial zone on the land area of the airport bounded by the runways.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader, and should not in any way be interpreted as limiting.

FIG. 1 illustrates a two dimensional layout of the proposed invention, showing the various areas associated with the invention.

FIG. 2 illustrates a perspective view of the proposed invention, giving a three dimensional view of the various areas and showing their interrelationships.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader, and should not in any way be interpreted as limiting.

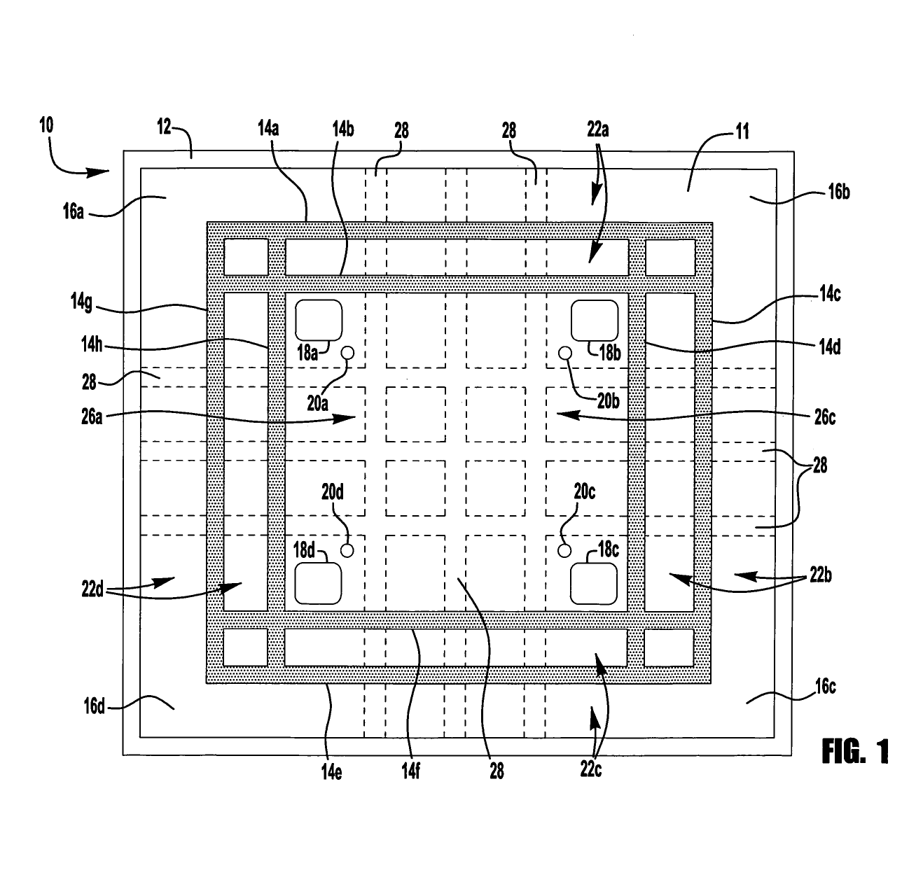

The present invention is directed to an environmentally-friendly, adaptable airport with renewable energy sources 10 (hereafter “airport”), as shown in FIG. 1. In general terms, airport 10 contains its own renewable energy sources, such as solar or wind powered generators, to reduce the need for typical, nonrenewable energy.

Referring to FIG. 1, the invention proposes an airport 10 to include a variety of constituent areas. In the preferred embodiment, the airport 10 would be laid out as a square. However it is within the terms of the invention to lay out the airport in any desired configuration.

Encompassing the perimeter of the land area 11 forming entire airport is a security zone 12 to patrol the surrounding area and ensure against unwanted or undetected entry onto the airport premises. In the preferred embodiment shown in the illustration, the airport 10 includes eight runways 14a-14h across the land area 11, with two running parallel and in close proximity to the edges of the airport 10 and the security zone 12. The runways 14a-14h run almost the entire length of the airport 10. In the space between the termination of each runway 14a-14h and the edge of the airport 10, is a network of runway turnoffs 16a-16d to enable landing aircraft to navigate off the runways 14a-14h onto a taxiway 17 leading to terminals 18a-18d. According to another embodiment, the runways 14a-14h are heated. The heat can be provided by the power generation systems 23 described herein. At the inside corners formed by the junction of the inside runways 14b, 14d, 14f, and 14h, terminals 18a-18d are situated. Each terminal 18a-18d features its own control tower 20a-20d to guide traffic in the region.

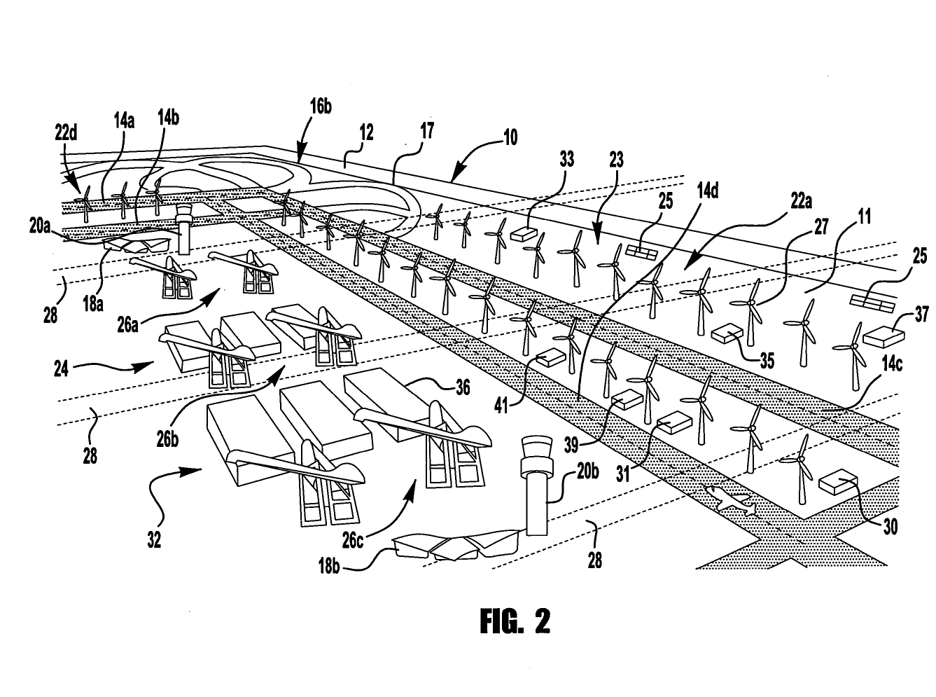

The preferred embodiment also includes fields 22a-22d with power generation systems 23, preferably generating renewable energy, such as solar collectors 25 and wind powered, electrical generators 27 flanking each set of runways 14a-14h. The wind powered, electrical generators 27 in fields 22a-22d would generate energy from the high level of wind present from the proximity to aircraft. The clean energy generated from fields 22a-22d containing power generation systems 23 such as solar collectors 25 and wind powered, electrical generators 27 would serve to reduce some of the airport-related pollution. In addition, the power generator systems 23 can include other types of renewable energy devices such as hydrogen fuel cells 30, geothermal power generators 31, solid oxide fuel cell generators 33, biomass power generators 35, magnetic power generators 37, hydrogen electrolysis generators 39, and hydrogen fusion power generators 41, generally as shown in the schematic illustration in FIG. 2.

In addition to the above described facilities, the airport 10 also includes an industrial zone 24 within the boundary formed by runways 14a-14h. This industrial zone 24 could consist of industrial facilities 32 such as furnaces, conveyors, die casting machinery, steam generators, helicopter landing pads and railroad lines according to the needs of local industry. Nearby the industrial facilities 32 are several banks of cranes 26a-26c to aid the loading of cargo, to be transported within the airport, locally and beyond. The industrial zone 24 can also include fire and security facilities as well as training facilities. Moreover, there can be provided fuel storage within industrial zone 24. The presence of an industrial zone 24 for manufacturing reduces transportation costs and associated pollution for delivering products to distant locations using airplanes.

Other facilities within the industrial zone 24 can be health facilities, a fitness center, a hospital, offices and warehouses.

Running beneath the airport 10 is a network of tunnels 28 to facilitate the movement of goods, equipment and personnel around the airport and to allow passengers and crews to traverse the runways and the industrial zone 24 to access the terminals 18a-18d.

FIG. 2 illustrates a perspective view of approximately the upper third of the airport 10. This view demonstrates a preferred embodiment of the invention as it might actually appear and shows clearly the interrelationship between the separate components of the invention. The crisscrossing pattern of the runways 14a-14h can be clearly discerned as well as the pattern of runway turnoffs 16a-16d disclosed in the present invention. Moreover, the illustration of FIG. 2 shows that the proximity of the runways 14a-14h to the power generation fields 22a-22d enables the runways to be heated by means such as steam which is generated in the power generation fields. The location of the power generation fields 22a-22d also lends itself to the efficient use of the power generated for the industrial zone 24. The illustration of FIG. 2 also portrays the central industrial zone 24 here comprising rows of modular buildings 36 housing industrial equipment disposed in industrial zone 24. Finally, the illustration demonstrates the position of the terminal areas 18a-18d (only 18a and 18b shown) vis-a-vis the runways 14a-14h and that the terminals 18 can be accessed via the underground tunnels 28.

According to an embodiment of the invention a method of operating an environmentally-friendly airport 10 with renewable energy sources. The method includes encompassing the land area 11 of the airport 10 with a security zone 12 and running a plurality of runways 14a-14h across the land area. Further, the method includes constructing one or more terminals 18a-18d within the security zone 12 encompassing the land area 11 of the airport 10. Fields 22a-22d are included for generating renewable, clean energy using a plurality of power generator systems within the land area 11. Finally, the method includes providing an industrial zone 24 on the land area 11 of the airport bounded by the runways 14a-14h.

The method of operating an environmentally-friendly airport also includes running two runways parallel to each other and in close proximity to the security zone 12. Further included in the method is enabling landing aircraft to navigate off one of the plurality of runways 14a-14h onto a taxiway 17 leading to one or more terminals 18a-18d using a network of runway turnoffs 16a-16d.

The method of operating an environmentally-friendly airport also includes providing renewable energy with the plurality of power generation systems which may include solar collectors 25, wind powered, electrical generators 27, hydrogen fuel cells 30, geothermal power generators 31, solid oxygen fuel cell generators 33 and biomass power generators 35.

The method of operating an environmentally-friendly airport 10 also includes providing each of the one or more terminals 18a-18d with its own control tower 20a-20d. Further, the method includes facilitating the movement of goods, equipment and personnel around the airport 10 utilizing a network of tunnels 28 beneath the airport.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. An environmentally-friendly airport with renewable energy sources, comprising:
a security zone encompassing the land area of the airport;
a plurality of runways across the land area;
one or more terminals within the security zone encompassing the land area of the airport;
a plurality of power generator systems within the land area for generating renewable, clean energy; and
an industrial zone within a boundary formed by the runways.

2. The environmentally-friendly airport of claim 1, wherein the security zone encompasses the perimeter of the airport to ensure against unwanted or undetected entry onto the land forming the airport.

3. The environmentally-friendly airport of claim 1, wherein the plurality of runways includes two runways running parallel to each other and in close proximity to the security zone.

4. The environmentally-friendly airport of claim 3, wherein a network of runway turnoffs enable landing aircraft to navigate off one of the plurality of runways onto a taxiway leading to one or more terminals.

5. The environmentally-friendly airport of claim 1, wherein the plurality of power generation systems includes solar collectors to provide renewable energy that can also reduce some of the airport-related pollution.

6. The environmentally-friendly airport of claim 1, wherein the power generation systems includes wind powered, electrical generators to provide renewable energy that can also reduce some of the airport-related pollution.

7. The environmentally-friendly airport of claim 1, wherein the plurality of power generation systems includes hydrogen fuel cell generators, geothermal power generators, solid oxide fuel cells, biomass power generators, magnetic power generators, hydrogen electrolysis generators, and hydrogen fusion power generators.

8. The environmentally-friendly airport of claim 1, wherein the industrial zone includes industrial facilities selected from the group consisting of furnaces, conveyors, die casting machinery, steam generators, helicopter landing pads and railroad lines.

9. The environmentally-friendly airport of claim 8, wherein the industrial facilities include several banks of cranes to aid the loading of cargo, to be transported within the airport, locally and beyond.

10. The environmentally-friendly airport of claim 9, wherein the industrial zone includes fire, security, and training facilities.

11. The environmentally-friendly airport of claim 1, wherein each of the one or more terminals has its own control tower.

12. The environmentally-friendly airport of claim 1, further including a network of tunnels beneath the airport to facilitate the movement of goods, equipment and personnel around the airport.

13. A method of operating an environmentally-friendly airport with renewable energy sources, comprising:
encompassing the land area of the airport with a security zone;
running a plurality of runways across the land area;
constructing one or more terminals within the security zone encompassing the land area of the airport;
generating renewable, clean energy using a plurality of power generator systems within the land area; and
providing an industrial zone on the land area of the airport bounded by the runways.

14. The method of operating an environmentally-friendly airport of claim 13, including running two runways parallel to each other and in close proximity to the security zone.

15. The method of operating an environmentally-friendly airport of claim 13, including: providing a plurality of runway turnoffs connected between the plurality of runways and a plurality of taxiways leading to the one or more terminals to enable landing aircraft to navigate from the one of the plurality of runways to the one or more terminals.

16. The method of operating an environmentally-friendly airport of claim 13, including: providing renewable energy with solar collectors whereby the plurality of power generation systems can reduce some of the airport-related pollution.

17. The method of operating an environmentally-friendly airport of claim 13, including: providing renewable energy with wind powered, electrical generators whereby the plurality of power generation systems can reduce some of the airport-related pollution.

18. The method of operating an environmentally-friendly airport of claim 13, including: providing renewable energy with hydrogen fuel cells, geothermal power generators and biomass power generators whereby the plurality of power generation systems can reduce some of the airport-related pollution.

19. The method of operating an environmentally-friendly airport of claim 13, including: providing each of the one or more terminals with its own control tower.

20. The method of operating an environmentally-friendly airport of claim 13, including: providing a network of tunnels beneath the airport for facilitating the movement of goods, equipment and personnel around the airport.
